(19) United States
(12) Patent Application Publication
(10) Pub. No.: US 2024/0029049 A1
(43) Pub. Date: Jan. 25, 2024

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Yuzo YAMADA, Nagoya-shi (JP); Yasunori NANYA, Nagoya-shi (JP)

(73) Assignee: TOYOTA JIDOSHA KABUSHIKI KAISHA, Toyota-shi (JP)

(21) Appl. No.: 18/354,278

(22) Filed: Jul. 18, 2023

(30) Foreign Application Priority Data
Jul. 21, 2022 (JP) 2022-116738

(51) Int. Cl. G06Q 20/32

(52) U.S. Cl. CPC G06Q 20/3263

(57) ABSTRACT

An information processing apparatus is an information processing apparatus that accepts a new user registration for a payment application installed on a user terminal. The information processing apparatus includes a processor. Upon receiving a user's identification information that is entered from a user registration screen of the payment application on the user terminal and that relates to a predetermined paying means, the processor acquires, from a server of the predetermined paying means, user information that corresponds to the identification information and that includes information required for payment by the paying means, and transmits the user information to the user terminal.

### CROSS-REFERENCE TO RELATED APPLICATION

This application claims priority to Japanese Patent Application No. 2022-116738, filed on Jul. 21, 2022, the entire contents of which are incorporated herein by reference.

### TECHNICAL FIELD

The present disclosure relates to an information processing apparatus and an information processing method.

### BACKGROUND

In systems for performing membership registrations, systems that improve convenience by eliminating time and effort relating to membership registrations are proposed. For example, Patent Literature (PTL) 1 discloses a system in which players perform membership registrations at amusement facilities. In this system, membership information registered by the players at the amusement facilities are stored in a center server. When the same players perform membership registrations at other amusement facilities, the membership information stored in the center server is used to save time and effort relating to information registrations.

### CITATION LIST

### Patent Literature

PTL 1: JP 2019-42366 A

### SUMMARY

In the field of payment applications, when new users perform membership registrations, it may take time and effort for the new users to register information.

It would be helpful to improve technology relating to new user registrations for payment applications.

An information processing apparatus according to an embodiment of the present disclosure is an information processing apparatus configured to accept a new user registration for a payment application installed on a user terminal, the information processing apparatus including a processor configured to:
upon receiving a user's identification information entered from a user registration screen of the payment application on the user terminal, the identification information relating to a predetermined paying means, acquire, from a server of the predetermined paying means, user information corresponding to the identification information, the user information including information required for payment by the paying means; and
transmit the user information to the user terminal.

An information processing method according to an embodiment of the present disclosure is an information processing method performed by a processor of an information processing apparatus configured to accept a new user registration for a payment application installed on a user terminal, the information processing method including:
receiving identification information entered from a user registration screen of the payment application on the user terminal, the identification information relating to a predetermined paying means;
acquiring, from a server of the predetermined paying means, user information corresponding to the identification information, the user information including information required for payment by the paying means; and
transmitting the user information to the user terminal.

According to the present disclosure, technology relating to new user registrations for payment applications can be improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a diagram illustrating the relationship between a paying means and payment means for payment service using a payment application;

FIG. 3 is a diagram illustrating a procedure for a new user registration for the payment application;

FIG. 4 is a flowchart illustrating a process executed by a first server; and

FIG. 5 is a diagram illustrating a procedure for viewing information on the paying means using the payment application.

### DETAILED DESCRIPTION

An embodiment of the present disclosure will be described below, with reference to the drawings.

### System Configuration

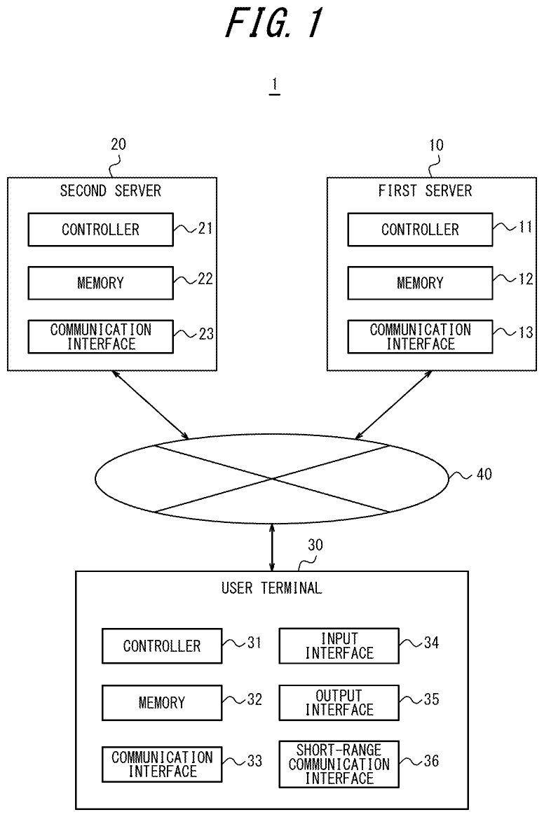

FIG. 1 is a block diagram illustrating a schematic configuration of a system 1 including a first server 10, i.e., an information processing apparatus according to an embodiment of the present disclosure. The system 1 includes the first server 10, a second server 20 (server of a paying means), and a user terminal 30. The first server 10, second server 20, and user terminal 30 are communicably connected to a network 40 including, for example, the Internet, a mobile communication network, or the like. For simplicity of explanation, one second server 20 and one user terminal 30 are illustrated in FIG. 1, but there may be multiple second servers 20 and user terminals 30, respectively. The functions of the first server 10 may be distributed to multiple pieces of hardware.

The first server 10 is a server that manages users of membership-based payment service using a payment application. The users install the dedicated payment application on the user terminals 30 and use the user terminals 30 to make payment for the purchase of goods and/or services at physical stores and/or Internet stores.

In an embodiment, the payment application is provided as an application that allows a user to selectively use multiple payment means. Such an application is sometimes referred to as a “wallet application”. The first server 10 that manages the “wallet application” is sometimes referred to as a “wallet server”.

The payment application cooperates with a “paying means” to perform payment. The paying means is a means for providing a paying source (also referred to as a “funding source”) for the payment application to make payment. The paying means includes a credit card, a bank account, prepaid electronic money, or the like.

The second server 20 is a server operated by a business that provides the paying means. The second server 20 is, for example, a server of a credit card company. The second server 20 provides services to users of the paying means, such as credit card members. The services provided by the second server 20 include the presentation of information and the provision of discounts, coupons, and the like. The presentation of information includes the presentation of the past use of the paying means, a next scheduled amount to be debited from a bank account, and the status of points held in a points service or the like. The second server 20 is set up with a user ID (user's identification information) and password for each user to log in to the system. The second server 20 does not assume the presence of the first server 10 and can independently provide the services to the users of the paying means.

The first and second servers 10 and 20 are, for example, computers such as server apparatuses. The first and second servers 10 and 20 are, for example, servers that belong to crowd computing systems or other computing systems. The first and second servers 10 and 20 are not limited to these, and may be any general purpose electronic devices such as personal computers (PCs), or may be any other electronic devices dedicated to the system 1. The first server 10 can communicate with the second server 20 and the user terminal 30 via the network 40.

The user terminal 30 is any electronic apparatus used by a user. The user terminal 30 may be, but is not limited to, a portable information terminal. For example, a general purpose or dedicated electronic device such as a smartphone, tablet, or PC can be used as the user terminal 30. The user can use the payment service by installing the payment application on the user terminal 30. The user may install the payment application on multiple terminals.

### Configuration of First and Second Servers

The first server 10 includes a controller 11, a memory 12, and a communication interface 13. The second server 20 includes a controller 21, a memory 22, and a communication interface 23. The first server 10 and second server 20 are similar in configuration and will be described together below.

Each controller 11 or 21 includes at least one processor, at least one dedicated circuit, or a combination thereof. The processor is a general purpose processor, such as a central processing unit (CPU) or a graphics processing unit (GPU), or a dedicated processor specialized for particular processing. The controller 11 executes processes related to operations of the first server 10 while controlling components of the first server 10. The controller 21 executes processes related to operations of the second server 20 while controlling components of the second server 20.

Each memory 12 or 22 includes at least one semiconductor memory, at least one magnetic memory, at least one optical memory, or a combination of at least two of these. Each memory 12 or 22 functions as, for example, a main memory, an auxiliary memory, or a cache memory. The memory 12 stores programs and data to be used for operations of the first server 10 and data obtained by the operations of the first server 10. The memory 22 stores programs and data to be used for operations of the second server 20 and data obtained by the operations of the second server 20. The information stored in each memory 12 or 22 may be updated with, for example, information acquired from the network 40 via the communication interface 13 or 23.

The memory 12 of the first server 10 stores user information associated with each user of the payment application. The user information includes identification information for identifying and authenticating the user, attribute information indicating attributes of the user, payment means information that is information on payment means to be used by the user, and paying means information that is information on paying means to be used by the user. The identification information includes, for example, a user ID and password. The attribute information includes, for example, a name, address, age, e-mail address, and the like. The payment means information includes, for example, information on available payment means, conditions for the use of each payment means, a usage history, and the like. The paying means information is information on a paying means associated with each payment means. The paying means information includes information required for payment by the paying means, such as a credit card number, a bank account number, or the like.

The memory 22 of the second server 20 stores user information for each user of the paying means. The user information includes the user's identification information, the user's attribute information, and the user's paying means information. The identification information includes a user ID and password at the second server 20. The user information may include the user's name, address, age, gender, and telephone number. The paying means information includes information required to perform payment by a member of the paying means. For example, when the paying means is a credit card, the paying means information includes a credit card number of the credit card held by the user.

Each communication interface 13 or 23 includes at least one interface for external communication for connecting to the network 40. The interface for communication may be either a wired or wireless communication interface.

Although the first and second servers 10 and 20 in FIG. 1 of the present embodiment are not described with input and output interfaces, the first and second servers 10 and 20 may further each include an input interface and an output interface. In other words, in addition to receiving (input) and transmitting (output) information via the communication interfaces 13 and 23, the first and second servers 10 and 20 may perform input and output of information via the input and output interfaces.

The functions of the first server 10 may be implemented by executing a program according to a method of the present disclosure by a processor corresponding to the controller 11. That is, the functions of the first server 10 are realized by software. The program causes a computer to execute the operations of the first server 10, thereby causing the computer to function as the first server 10. That is, the computer executes the operations of the first server 10 in accordance with the program to thereby function as the first server 10.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory.

### Configuration of User Terminal

As illustrated in FIG. 1, the user terminal 30 includes a controller 31, a memory 32, a communication interface 33, an input interface 34, and an output interface 35. The user terminal 30 may further include a short-range communication interface 36.

The controller 31 includes at least one processor, at least one dedicated circuit, or a combination thereof. The controller 31 executes processes related to operations of the user terminal 30 while controlling components of the user terminal 30.

The memory 32 includes at least one semiconductor memory, at least one magnetic memory, at least one optical memory, or a combination of at least two of these. The memory 32 stores programs and data to be used for operations of the user terminal 30 and data obtained by the operations of the user terminal 30. The information stored in the memory 32 may be updated with, for example, information acquired from the network 40 via the communication interface 33. The memory 32 may store a program for the payment application and data used by the payment application.

The communication interface 33 includes at least one interface for external communication for connecting to the network 40. The communication interface 33 receives data to be used for the operations of the user terminal 30, and transmits data obtained by the operations of the user terminal 30 to the outside (for example, the first server 10).

The input interface 34 includes at least one interface for input. The interface for input is, for example, a physical key such as a keyboard, a capacitive key, a pointing device, or a touch screen integrally provided with a display. The interface for input may be, for example, a microphone that accepts audio input, a camera that accepts image input, or the like. The input interface 34 accepts an operation for inputting data to be used for the operations of the user terminal 30. The input interface 34, instead of being included in the user terminal 30, may be connected to the user terminal 30 as an external input device.

The output interface 35 includes at least one interface for output. The interface for output is, for example, a display for outputting information in the form of an image, a speaker for outputting information in the form of audio, or the like. The display is, for example, an LCD or an organic EL display. The output interface 35 outputs data received from the first server 10, data obtained by the operations of the user terminal 30, or the like. The output interface 35, instead of being included in the user terminal 30, may be connected to the user terminal 30 as an external output device.

The short-range communication interface 36 includes an interface for communication that performs, in particular, short-range wireless communication with a payment terminal at a physical store, when the user makes a purchase of goods or services at the store or other location. The short-range communication interface 36 may have communication functions compliant with standards such as Near Field Communication (NFC), Bluetooth® (Bluetooth is a registered trademark in Japan, other countries, or both) Low Energy (BLE), and Infrared Data Association (IrDA).

### Relationship Between Payment Application and Paying Means

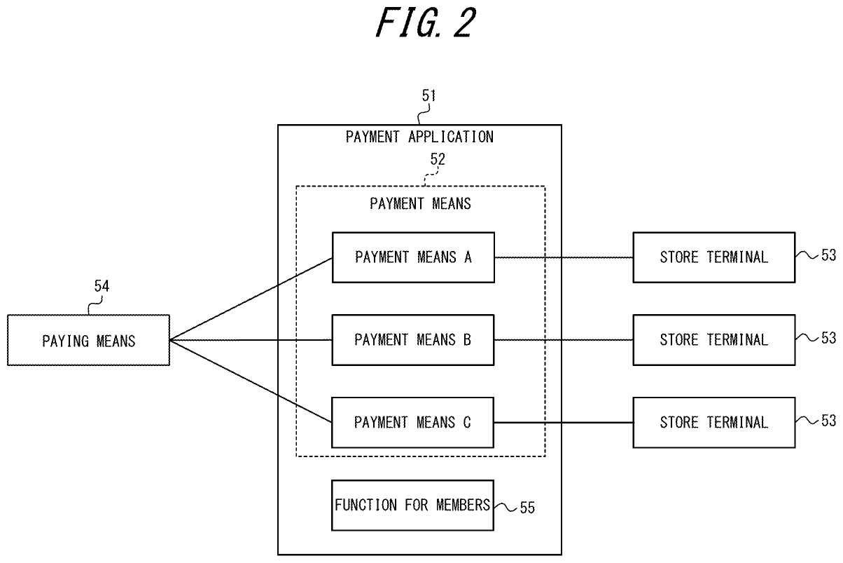

As illustrated in FIG. 2, a payment application 51 provides payment means 52 and a function 55 for members. The payment application 51 may support various payment means 52. The payment means 52 include, for example, a method in which a bar code or two-dimensional code is displayed on a display, i.e. the output interface 35 of the user terminal 30, and is read by a store terminal 53, i.e. a store-side terminal. The payment means 52 include a method in which a bar code or two-dimensional code presented by a store is read by a camera included in the input interface 34 of the user terminal 30. Furthermore, the payment means 52 include a method of transmitting and receiving data between the short-range communication interface 36 and a store terminal 53 via short-range wireless communication. There are a lot of payment means offered under various brand names (e.g., “** PAY”). On the other hand, the store terminal 53 generally does not support all payment means. A user of the payment application 51 can select an available payment means from among the plurality of payment means 52 registered in the payment application 51. The function 55 for members is the function of providing various types of information, benefits, and the like to the user of the payment application.

Each payment means is tied to a paying means 54 and performs payment using the paying means 54. The paying means 54 includes prepaid, postpaid and debit methods. Specifically, the paying means 54 includes postpaid credit cards that provide post-payment within a credit limit by a card issuer, debit cards that provide an immediate debit from a bank account, prepaid electronic money in which an amount to be used is deposited in advance, and the like. For example, when the paying means 54 is a credit card, the consideration for the purchase of goods and/or services using the payment means 52 is ultimately settled by the credit card. In FIG. 2, only one paying means 54 is described, but paying means 54 are not limited to one. The user needs to register one or more paying means 54 at the payment application.

### Procedure for New User Registration

New users of the payment service using the payment application each need to perform the following several tasks to start using the payment service.
(1) Download and install the payment application on the user terminal 30.
(2) Actuate the payment application and set and register a new ID (identification information) and password.
(3) Register user information such as a name, telephone number, and e-mail address from a user information registration screen.
(4) Register a payment means to be used by the user.
(5) Register a paying means available to the user.

However, such a procedure for a user registration can be complicated for the users. Especially, the registration of the paying means requires having a credit card on hand and typing in a high-digit credit card number or taking a picture of the credit card number with a camera. This complexity of the user registration becomes an obstacle for the general public to register as new users.

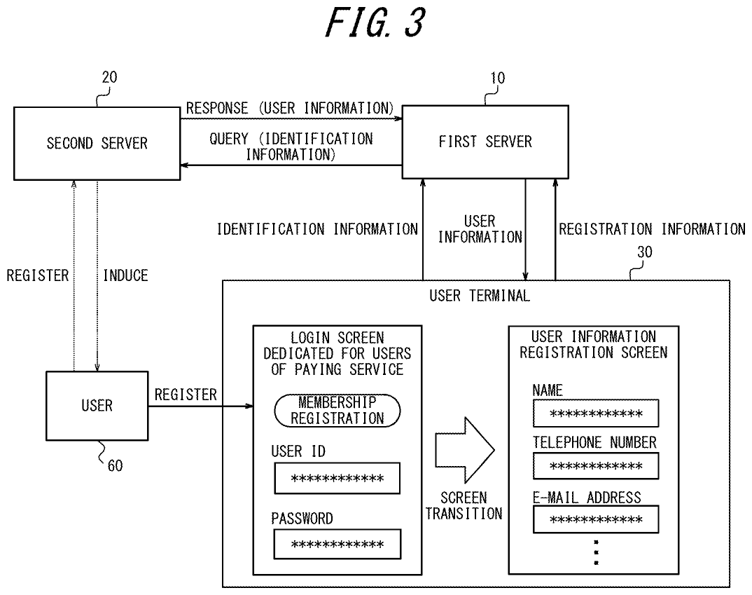

Therefore, in the system 1, a provider of the payment application cooperates with a business providing the paying means. For example, it is assumed that the provider of the payment application and the provider of the paying means may be the same or in a partnership. Specifically, the first server 10 and the second server 20 coordinate information so that members of the paying means can easily register as new members of the payment application. In this case, an example of a procedure for a new membership registration for the payment application will be described with reference to FIG. 3.

First, assume users 60 who have already or newly registered at a paying means. For example, a provider of the paying means sends, using e-mail addresses of the users 60 registered on the second server 20, e-mails soliciting the use of a payment application to the users 60. For example, the provider of the paying means may mail printed materials soliciting the use of the payment application to addresses of the users 60 registered on the second server 20. From address information on a site of the payment application contained in the e-mails and/or printed materials, the users 60 can each easily access the site of the payment application using the user terminal 30 and acquire the payment application.

When a user 60 installs the payment application on the user terminal 30 and actuates the payment application, the controller 31 on the user terminal 30 controls the output interface 35 to display a new user login screen (user registration screen) dedicated for the users 60 of the specific paying means, which is induced from the specific paying means. This login screen includes an input area for a user ID and password. The user 60 can enter, in this input area, the same user ID and password as those used to use the service of the second server 20 associated with the paying means.

The entered user ID and password are transmitted, as identification information, from the user terminal 30 to the first server 10 via the communication interface 33. The controller 11 of the first server 10 transmits the user ID and password to the second server 20 via the communication interface 13 to make an inquiry about the use of the paying means by the user 60 who has entered the identification information in the user terminal 30.

Upon receiving the user ID and password from the first server 10, the controller 21 of the second server 20 verifies whether the combination of the received user ID and password is included in identification information stored in the memory 22. When the combination of the user ID and password is included in the memory 22, the controller 21 transmits user information on the user stored in the memory 22 to the first server 10 via the communication interface 23.

Upon receiving the user information from the first server 10, the controller 31 of the user terminal 30 displays a user information registration screen on the display, i.e. the output interface 35. In the displayed user information registration screen, at least part of the user information acquired from the first server 10 is set in advance. For example, the user information registration screen displays pre-populated information such as a name, telephone number, and e-mail address, without input from the user 60. Therefore, the user 60 can save time and effort to enter such information.

The user 60 may use the user ID and password registered as a member of the paying means as is, as a user ID and password for the payment application. The user 60 may also set, as a user ID and password for the payment application, a different user ID and password from the user ID and password registered as a member of the paying means. The user 60 may change part or all of the user information displayed on the user information registration screen. When the user 60 operates the input interface 34 of the user terminal 30 to command a registration of the user information, the user information entered in the user information registration screen is transmitted, as registration information on the user 60, to the first server 10 via the communication interface 33.

Upon receiving the registration information on the user 60 via the communication interface 13, the controller 11 of the first server 10 stores the registration information in the memory 12. In a case in which the user 60 sets different identification information from the identification information for the paying means, the controller 11 stores, in the memory 12, the identification information for the payment application and the identification information for the paying means in correspondence with each other. The paying means whose identification information has been used to register the user 60 with the payment application is automatically registered at the first server 10. The user 60 may operate the user terminal 30 to register another paying means, if necessary.

As described above, according to the present embodiment, the user 60 who is a member of the paying means and a new user of the payment application can easily perform a membership registration for the payment application. In the registration for the payment application, the user 60 can at least partially omit operations involved in registering the paying means and registering the user information. In particular, the user 60 can omit a complicated registration of the paying means. For example, in the new membership registration, the user 60 does not have to have a credit card in hand and type in a credit card number. Thus, according to the present embodiment, technology relating to new user registrations for payment applications is improved.

### Processes Executed by Controller of First Server

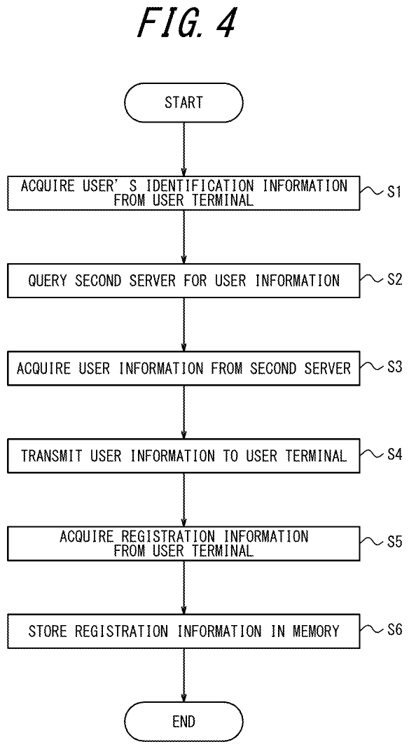

Next, processes performed by the controller 11 of the first server 10, when a user 60 who is a member of a paying means registers as a new member of a payment application, will be described with reference to the flowchart in FIG. 4.

First, when the user 60 actuates, using a user ID for a membership of the paying means, a membership registration from a registration screen dedicated for users of a specific payment means, the controller 11 acquires identification information for the specific paying means transmitted from the user terminal 30 via the communication interface 13 (step S1).

Upon acquiring the identification information, the controller 11 transmits a query for user information to the second server 20 via the communication interface 13 (step S2).

The controller 11 acquires, from the second server 20 via the communication interface 13, the user information stored in the memory 22 of the second server 20 (step S3). The user information includes paying means information, which is information on the paying means to be used by the user 60, and attribute information on the user 60.

The controller 11 transmits part or all of the user information acquired from the second server 20 to the user terminal 30 via the communication interface 13 (step S4).

After step S4, the controller 11 acquires registration information on the user 60 from the user terminal 30 via the communication interface 13 (step S5). The registration information on the user 60 includes information added and changed by the user 60 on a user information registration screen with respect to the user information transmitted in step S4.

The controller 11 stores, in the memory 12, the registration information acquired in step S5 together with the identification information and paying means information (step S6), and then ends the user registration.

As described above, since at least part of the information required for the user registration is acquired from the second server 20 in step S3 and provided to the user terminal 30, the first server 10 can reduce a burden on the user related to an information registration for the payment application.

### View of Information on Paying Means Using Payment Application

For the user 60 who has performed a registration for the payment application in cooperation with the second server 20, the first server 10 can easily display information on the paying means in cooperation with the second server 20 and the payment application on the user terminal 30. The information on the paying means includes, for example, when the paying means is a credit card, a usage record of the credit card, a next scheduled date and amount to be debited from a bank account, points held in a points service, and the like.

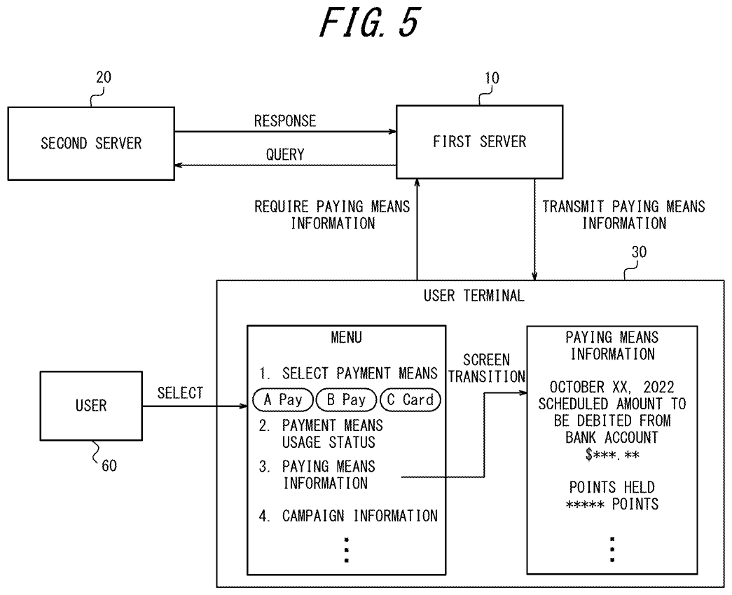

For example, as illustrated in FIG. 5, when the user 60 actuates the payment application on the user terminal 30, a menu including the selection of available payment means and the provision of information for a member is displayed. This menu may include an option to display the paying means information. For example, in FIG. 5, when the user 60 selects “PAYING MEANS INFORMATION”, the user terminal 30 transmits, to the first server 10, a request message for the paying means information including the user ID (identification information). Upon receiving the request message for the paying means information via the communication interface 13, the controller 11 of the first server 10 transmits the user ID (identification information) to the second server 20 to acquire information regarding the use of the paying means by the user 60. The first server 10 transmits the information regarding the use of the paying means to the user terminal 30. Thereby, the controller 31 of the user terminal 30 controls the display of the output interface 35 to display the information on the use of the paying means.

In this way, the user 60 can easily view the information on the paying means on the payment application, without separately operating the user terminal 30 and transmitting an inquiry to the second server 20. Thus, the user 60 can view not only information on the use of each payment means, but also the information on the paying means, with the use of the single payment application. This will further improve convenience for users of the payment application.

It should be noted that the present disclosure is not limited to the above embodiment, and various modifications and revisions can be implemented. For example, functions or the like included in each means, each step, or the like can be rearranged without logical inconsistency, and a plurality of means, steps, or the like can be combined into one or divided.

1. An information processing apparatus configured to accept a new user registration for a payment application installed on a user terminal, the information processing apparatus comprising a processor configured to:
upon receiving a user's identification information entered from a user registration screen of the payment application on the user terminal, the identification information relating to a predetermined paying means, acquire, from a server of the predetermined paying means, user information corresponding to the identification information, the user information including information required for payment by the paying means; and
transmit the user information to the user terminal.

2. The information processing apparatus according to claim 1, wherein
the paying means is a credit card, and
the user information includes a credit card number of the credit card held by the user.

3. The information processing apparatus according to claim 1, configured to:
acquire, from the payment application on the user terminal, the identification information on the registered user;
transmit the identification information to the server of the paying means;
acquire information regarding use of the paying means by the user; and
transmit, to the user terminal, the information regarding the use of the paying means by the user.

4. The information processing apparatus according to claim 3, wherein the information regarding the use of the paying means by the user includes information on points held in a points service.

5. An information processing method performed by a processor of an information processing apparatus configured to accept a new user registration for a payment application installed on a user terminal, the information processing method comprising:
receiving identification information entered from a user registration screen of the payment application on the user terminal, the identification information relating to a predetermined paying means;
acquiring, from a server of the predetermined paying means, user information corresponding to the identification information, the user information including information required for payment by the paying means; and
transmitting the user information to the user terminal.
